(19) United States
(12) Patent Application Publication
(10) Pub. No.: US 2003/0182303 A1
(43) Pub. Date: Sep. 25, 2003

(54) System and method for automated database report definition

(76) Inventor: Stephen D. Gibson, Kemptville, CA (US)

Correspondence Address: PEARNE & GORDON LLP, 526 SUPERIOR AVENUE EAST, SUITE 1200, CLEVELAND, OH, 44114-1484, US

(21) Appl. No.: 10/366,091

(22) Filed: Feb. 12, 2003

(30) Foreign Application Priority Data
Feb. 12, 2002 (CA) 2,371,724

(51) Int. Cl. G06F 17/00

(52) U.S. Cl. 707/102

(57) ABSTRACT

The invention discloses a method and system for defining prompts using declarative principles. By providing the means to specify various elements used in reports in a formal manner the invention allows report authors to easily and rapidly create effective customised reports, at the same time ensuring consistent styles are used. It achieves this without increasing the risk of damaging the integrity of the underlying data. The invention formalises much of what was previously implemented in an ad hoc manner, and automates aspects that previously required the intervention of a database administrator and associated system programmer.

### BACKGROUND OF THE INVENTION

The present invention relates to database processing for which information is interactively prepared for visual display, particularly in relation to business intelligence and decision support systems.

In the world of business intelligence plans and forecasts are derived from data stored in very large corporate databases, sometimes known as data warehouses or data repositories. There is a need to provide consumers, that is managers and other decision makers and planners, with report generation tools that allow them to extract relevant data from complex environments interactively, and manipulate it, often in ways that cannot always be completely foreseen by the database administrator and associated system programmers who typically write the programs and tools used to produce reports. Typically, ad hoc tools are created, and in some cases these are then further developed, adjusted and altered by people other than the authors of the original report or the system programmers to provide another view of the data required by the user. Such ad hoc tools can be relatively inefficient, both in their manner of production, (that is, by individuals working alone, and without proper programming environment support, particularly a full history repository and code review process) and in their implementation (since the code is not shared, nor available to be shared, with like-minded individuals—leading to duplication of effort). The individuals who provide this invaluable service are effectively report authors themselves, albeit sophisticated consumers, and become known as local ‘gurus’. Although they have sufficient skills to produce these ad hoc tools, they typically have limited abilities in the programming domain. Where such ‘gurus’ are not present, the report authors have found themselves restricted in their ability to ‘play’ with the data views to match their needs since the limited filtering and report layout have of necessity been done without their immediate input. Their only recourses have been either to learn the requisite skills and become ‘gurus’ themselves, or to put in a request to the database administrator and system programmer organisation for an enhancement to the formal tools, both activities requiring much time and effort to achieve the desired results.

In the past several attempts have been made to improve the effectiveness of users and their supporting ‘gurus’, and these efforts continue to evolve. U.S. Pat. No. 6,160,549 “Method and apparatus for generating reports using declarative tools”, Touma et al, and U.S. Pat. No. 5,809,266 “Method and apparatus for generating reports using declarative tools” Touma, et al. concentrate on expanding the role of declarative tools to encompass several different databases, and produce static reports. Many of them include the provision and support of macro-based languages, and relatively simple programming languages, such as Microsoft Visual Basic as well as GUI-based design tools. However, the use of such tools in combination requires some ability in programming, and typical users do not have the training, nor is the required skill level easily attained. Several patents, among them U.S. Pat. No. 5,133,070 “Method of nesting and processing mixed data objects within a data stream utilizing selective environment inheritance”, Barker et al., and U.S. Pat. No. 5,410,692 “Method for enhancing interactive query of a database”, Torres, concentrate on providing enhancements to such tools rather than providing new tools.

Other approaches have included concepts such as those described in U.S. Pat. No. 5,806,060 “Interactive data analysis employing a knowledge base” Borgida et al, in which an information retrieval system is implemented as a virtual data base management system which uses a knowledge base management system to provide a problem-oriented conceptual schema for one or more standard data base management systems.

U.S. Pat. No. 5,778,377 “Table driven graphical user interface”, Marlin, et al. uses pre-defined report definitions, thereby restricting the consumer.

U.S. Pat. No. 5,937,155 “Interactive report generation system and method of operation”, Kennedy, et al. describes a system that generates a worksheet template comprising a number of cell templates each defining a model-dependent expression. An evaluator generates a worksheet instance. No consideration is given here to allowing free expression of how the report might look, since templates, by definition, restrict the user.

U.S. Pat. No. 5,721,903 “System and method for generating reports from a computer database” Anand, et al. is directed at generating a report for a user which allows the user to make decisions, without requiring the user to understand or interpret data itself. Although it reads data from the database, creates the data types, and creates a mapping of the data types to the data, it does not permit ease of changing the report format.

A further approach involving a restricted access environment, sometimes known as the ‘sandbox’ method, wherein the ability of a user to cause problems for the overall system or for other users is severely restricted, has been used with some success, but has the disadvantage that full control of system integrity is difficult to accomplish without extensive testing, and in some cases has proven to be on ongoing issue.

What is needed is the ability to produce rich, dynamic interaction with data, at the same time providing the consumer with the ability to more easily customize already created reports, thereby facilitating rapid, intelligent interpretation of the data.

### BRIEF SUMMARY OF THE INVENTION

To overcome the limitations in the prior art described above, and to overcome other limitations that will become apparent upon reading and understanding the following specification, the present invention discloses a novel method and system for defining prompts for use in report preparation Embodiments of the invention allow report authors, among others, to easily and rapidly create effective customised reports. The invention also allows reports to be produced that promote the use of consistent styles across a company, within a specific division of a company, or across group of related companies. It does this by allowing locale dependent preferences to be incorporated in the report design. Embodiments of the invention allow these advantages to be easily realized while maintaining data integrity.

In a first aspect the invention provides a method for authoring reports and producing instantiations of the reports from data stored in a database, including the steps of authoring a report layout according to a report author's needs, using declarative principles and the database; and, using the report layout in association with the database, creating reports according to the report layout and parameters chosen by a consumer.

In a second aspect, the invention provides a computer-based system for producing reports from data stored in a database, the system using prompts based on declarative principles, comprising means for authoring a report layout comprising means for allowing a report author to select prompt controls, for each prompt control, means for providing the report author with a list of valid parameters from which to make a selection, means for displaying a resulting report layout means for using the report layout comprising means for presenting a consumer (who may be the report author) with the report layout means for accepting from the consumer one or more parameter values selected using the prompt controls means for formulating a data request optionally using filters constructed from the one or more parameter values means for sending the data request to a data source means for receiving from the data source the results of the data request and means for displaying to the consumer a report defined by the report layout and containing data based on the received data.

In providing a method and system to alleviate the problems outlined above, embodiments of the present invention have also been shown to result in improvements both to the usefulness of the resulting reports and to overall system efficiencies in terms of computing performance and software development. In addition, one of the major frustrations of a typical report authoring process is removed, in that no third party is required to be directly involved in the development of a new report.

Embodiments of the invention allow the comparatively untrained report authors, rather than system programmers, to produce relatively complex reports incorporating a number of prompt controls by declaring or defining a few properties, each property capable of being assigned a value, or range of values, or a more complex function (evaluated at runtime) for each prompt control or group of related prompt controls a few properties. Based on those declarations, and with the addition of information collected at runtime (from the database, and the consumer, for example) the report author or consumer is able to produce complex reports giving a rich, interactive reporting experience to all users of the report.

### BRIEF DESCRIPTION OF DRAWINGS

Embodiments of the invention are described with reference to the following figures:

FIG. 1 shows a distributed programming environment in which the invention may be practised.

FIG. 2 Shows the various logical components of the system.

FIGS. 3 and 4 give two examples of elements of user interfaces resulting from the use of embodiments of the invention.

### DETAILED DESCRIPTION OF THE INVENTION

The following definitions of terms used in this description are given here for convenience and clarification:

| | |
|---|---|
| Client/ | The portion of the system that interacts with the |
| Client-Side | consumer or report author. |
| Consumer | The person running the report to get information. |
| Prompt control | A mechanism for adjusting the selection of data used in |
| | producing a report. |
| Locale Aware | The property of a Prompt control that allows it to take a |
| | Consumers regional preferences (such as language, |
| | terminology, time and date formats) into account. |
| Parameter | A parameter is simply a placeholder for a value. It is |
| | used within expressions. |
| Prompt | A prompt collects a value from a consumer. This value is |
| | then used to replace a parameter with the same name. |
| Report | Final result showing only the data in which the consumer |
| | is interested. |
| Report Author | Person creating the report for use by the consumer. |
| Running a | The process of causing data determined by the various |
| report | Prompts and Parameter values in a report layout to be |
| | retrieved from the database and displayed accordingly. |
| Server | Some mechanism or process that interprets the |
| | declarative specification. |

Embodiments of the invention evolved from the realisation that it is possible to affect the appearance of most, if not all, of the controls used in the production of a consumer interface for report authors through the use of parameterisation. This required the formalisation of much of what was previously implemented in an ad hoc manner, and automation of what had previously required the intervention of a database administrator and associated system programmer. This has not been achieved in the same way in any previously reported technique.

Embodiments of the invention are best described in the context of a number of examples of prompt controls used in the design and use of reports, or rather report layouts. Outlines of other typical prompt controls are also included, although not all possible prompt controls are described either in detail or in outline.

In summary, the life cycle of a report may be considered as follows:

A ‘report author’—using an embodiment of the invention—puts together a ‘report layout’

The ‘report layout’ includes one or more ‘declarative prompts’ or prompt controls (as defined herein).

The result of a ‘consumer’ ‘running’ this ‘report layout’ ‘against some data’ (i.e. retrieving, filtering, etc, the data as required) is a ‘report’ which itself may include one or more ‘declarative prompts’ and is therefore itself a kind of ‘report layout’.

Once the ‘consumer’ has ‘run’ the ‘report layout’, using the one or more ‘declarative prompts’, other values can be chosen/selected for the parameters associated with the one or more ‘declarative prompts’ and the ‘report’/‘report layout’ is refreshed/‘run again against the data’.

In some instances there are no ‘declarative prompts’ on the ‘report’ (and this simpler case might be worth describing separately) and hence the ‘report’ is not dynamic, so that a different set of values for the parameters requires the ‘consumer’ to start afresh with another instantiation of the ‘report layout’.

In other instances placeholders, known as ‘generated prompts’, are used which are replaced during processing with other prompts, the type of prompt being determined by, for example, preference data stored in the database, data type, and expression context such as whether single or multi-values are used.

The invention is such that the report author is presented with only those controls that are relevant, and in determining the appearance of the control, only those parameters or features that are valid to use are available for selection. This aspect of declaring prompts is invaluable when the tool is to be used by people who are otherwise incapable (by virtue of lack of training or experience) to design reports making use of these controls. A variety of mechanisms may be used in implementing the invention, however, it is the concepts behind the implementation that provide the benefits and improvements over previous report authoring tools. For a person skilled in the art, it is sufficient that these concepts be well understood, leaving the implementor to select from the many options available the exact mechanism for implementation.

In order to more fully explain the advantages of the invention, we describe a number of typical controls including the effect that the invention has on their presentation to the report author.

One feature of prompting often met is something called “cascading prompts”. In this, the ‘parent’ prompt control drives, or affects, the contents of the ‘child’ prompt controls. In some cases the ‘child’ becomes the ‘parent’ of a further ‘child’ prompt control, and in fact there is no real limit to the number of prompt controls in a cascading series. It is often necessary for a user to select a city from a list that may contain an enormous number of values if it contains cities from around the world. This can be made easier, or faster, less daunting even, by first having the user respond to a prompt for a continent—a ‘parent’ prompt—, then a ‘child’ prompt for a country—itself a ‘parent’ prompt—, and finally a further ‘child’ prompt for a city. When the consumer selects “Europe” from the first prompt, the first ‘child’ cascade will show only those countries that are in Europe. If the consumer then chooses “Scotland” the final prompt would show only the cities in the Scotland, such as “Dundee”, “Glasgow”, “Edinburgh”.

Traditionally, this has been very difficult to arrange as a simple implementation since the report author was expected to understand queries and the relationships in the database. Such complex prompt controls have therefore been limited to reports authored by systems programmers, or at least having their direct involvement. This level of understanding is not something expected of a more-or-less casual user, or even a ‘power user’ who might have little or no formal programming or database experience. The Declarative Prompt Specification mechanism of an embodiment of the invention only requires that the report author insert three Value Prompt controls into the report layout together with information relating them in the form of declarations. As a minimum, the report author need only select from a limited number of intuitive responses that allow these three Value Prompt controls to be linked. For example, in the preceding case, the minimum necessary declarations are that the “Cascade Source” property of the first child be set to “Continent”, and the “Cascade Source” property of the last child be set to “Country”. Note that it is the job of the server to determine all the necessary queries, including defaults where needed, to produce the desired effect without further involving the report author in generation of the required code or macros that perform the operations when running the report. Although other properties are usually required to fully describe and define these prompt controls, a discussion of them is omitted here to simplify the description. Thus the report author need only be concerned with those aspects of the control that affect the consumer of the report, an understanding of and exposure to the underlying mechanisms not being necessary.

The creation of complex range filters has also been found to be a challenge for untrained report authors, in the past requiring the intervention of system programmers, or in some cases forcing the users to generate multiple reports requiring later (perhaps manual) compilation into a single report. For example, the report author or consumer may wish to include all the orders in a number of (unrelated) date ranges: say—May 29, 1990, between Mar. 1, 1992 and Mar. 31, 1992, and after May 1, 2000. Creating this filter the traditional way is very difficult. The report author would have been expected to understand the native expression syntax for the database being used, generally deemed arcane and inelegant. The Declarative Prompting Specification mechanism of an embodiment of the invention allows the report author to insert a Date Prompt control into the specification, and set the “multi-select” and “range” properties to “true”. This causes the User Interface (UI) to be generated in such a way as to allow selection of complex ranges and the server to formulate the appropriate expression. Again, the invention permits the user to construct these complex filters without being concerned with the implementation, needing only to declare values for the necessary and optional properties of the control. As before, although other properties are usually required to fully describe and define these prompt controls, a discussion of them is omitted here to more clearly illustrate the invention.

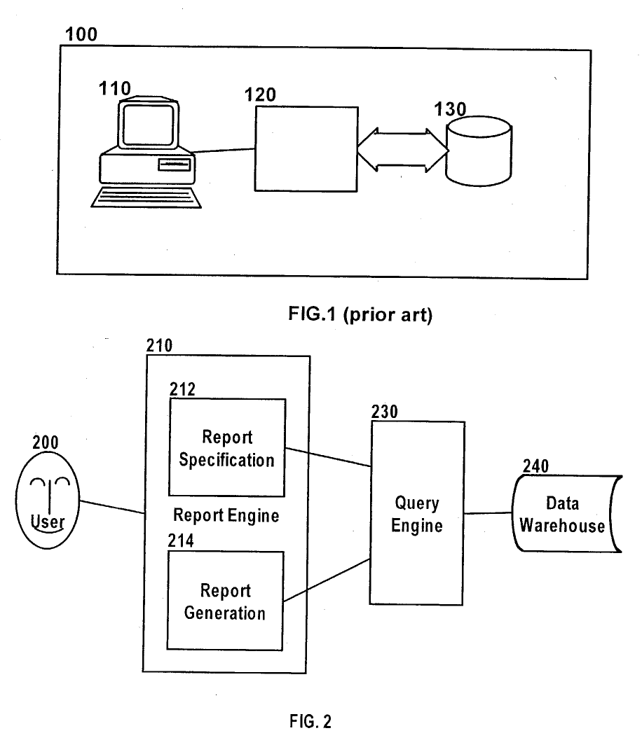

Various embodiments of the invention are now described in relation to a relatively simple client-server business intelligence environment, although, as one skilled in the art would recognise, the techniques are applicable to more complex and extended environments. Further, the location of any particular logical function may be varied (such as between a client computer and a server computer) without affecting the nature of the invention, but rather the choice of the location may be made to reflect the particular environment and the efficiency of operation, etc. The FIG. 1 shows such a suitable client-server network 100, in which a client 110 is attached to a server 120 that accesses mass storage 130 on which various data and programs may be stored. Typically the client 110 is a workstation and comprises a web browser and ancillary software. The server may be any suitably configured computer, and the mass storage 130 may comprise one or more physical disk drives (or equivalent devices) configured as a data warehouse or database.

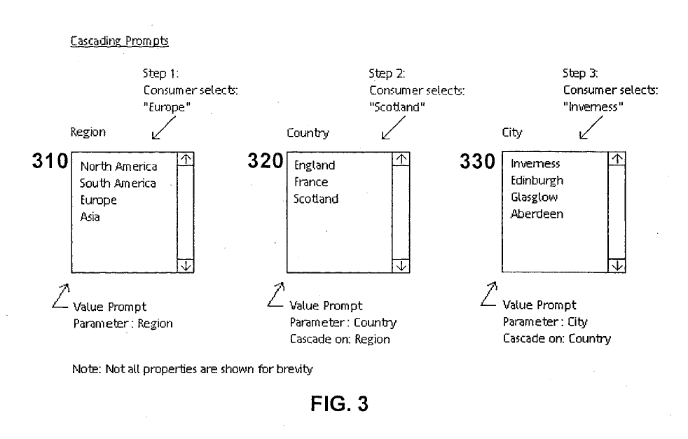

FIG. 2 shows the relationships of the various logical components in an embodiment of the system. In this, a consumer or report author 200 interacts with a Server 210 that may request information from the database or data warehouse 240 using a Query Engine 230. The Server incorporates various modules implementing two main functions, those of Report Layout 212, and Report Generation 214. It is within these two functions that embodiments of the invention reside.

The Report Layout function 212 provides a consumer or report author 200 with a full set of prompt controls and related formatting options to permit the report author to define a report layout and hence the resulting reports in sufficient detail for their needs, and for the consumer to perform data analysis. Optionally It also provides, in collaboration with the Query Engine 230, a consistency check of the prompt controls and other options. The resultant specification is passed to the Report Generation function 214 that produces a report, also in collaboration with the Query Engine 230. The Report Generation function 214 may require one or more iterations or interactions with the Query Engine 230 to resolve various optional parameters used for queries and in some cases for generating prompts, these parameters themselves being stored in the database or data warehouse 240. Optional parameters as well as any extra relationships may be added to the database 240 as required for the Report Generation function 214.

A typical sequence of actions required to produce a report layout using an embodiment of the invention includes:

the report author selects one or more prompts to be incorporated into the report layout.

for each prompt, the report author is required to either accept default settings for parameters for the selected prompt or to select from a number of options.

an optional consistency check is performed to ensure that the controls correctly reflect the structure of the underlying database.

the previous step are repeated until the user is satisfied with the report layout, and all of the prompts pass the optional consistency checks.

The resultant report layout, in the form of a specification is then passed to the Report Generation function 214 where a further series of processing steps takes place (not described here) as would be normal for a report generated by any method with the important exception that in some embodiments optional parameters used in the generation of prompts and their subsequent queries are required to be resolved by accessing the database in order to fully form the prompts and queries.

The functions outlined above are next described using examples. Again, the examples are not exhaustive, but serve to exemplify preferred embodiments.

Referring again to FIGS. 1 and 2, the Report layout function 214 is described in terms of the user interface implemented on a workstation 110 as part of a client-server network 100. In one embodiment the graphical user interface for this function includes a work sheet on which the report layout is rendered, together with a series of tool palettes or menus that the report author can use to select from a number of prompt styles, and other common graphical editing tools (such as ‘drag and drop’, graphics insertion). Prompt styles define the physical appearance of prompt controls and related parts thereof. Prompt controls can have several styles associated with them. First, a style is specified for the actual prompt control. Second, a style is applied specifically to the caption or help text. Thus, any style set for the prompt control applies to all User Interface pieces of the prompt control except the caption and help text.

In some embodiments using aggregate prompt controls, such as Date Prompt controls and Date Time Prompt controls, different styles may be applied to the individual pieces (e.g. the style used for day-of-week selection is different from that used for the year selection.)

The following is an illustrative list of prompt controls that can be declared with their associated properties used in an embodiment of the invention. The examples serve to indicate typical relevant parameters and properties of the exemplary prompt controls and should not be considered limiting. They indicate the richness of the environment provided to report authors who need only set the properties of the chosen prompt controls to provide an intelligent and extensive prompting solution.

In this list, the words “server interprets” or “server generated prompt control” show that the server interprets the prompt declarations and an intelligent prompt control is generated.

The procedure is as follows:

1. The report author uses the declarative prompting specification to add prompting capabilities to a report layout;

2. The server interprets this declarative prompting specification to generate one or more prompt controls that the consumer, who may be the report author or a third party, can interact with;

3. The consumer enters data or makes selections and submits this to the server;

4. The server uses these values and the declarative prompting specification to formulate the query based on the report layout to get the desired results; typically this means that the data included in the report is filtered, but it may not be. Prompts may be used to vary selections, as well as to define parameters used in calculations and any filtering operations

Value Prompt

The value prompt is used to select a value from a list. Based on its properties, it can be populated by choices entered by the author or by values in a database.

| Property Name | Description |
|---|---|
| Required | Indicates whether or not the consumer must enter a value |
| | before the report is executed. The server will interpret |
| | this property and build the appropriate filter relieving |
| | the report author from the need to understand optional |
| | and required filters. |
| Multi-Select | Determines if the prompt control will accept only a single |
| | value or more than one value. The user interface and |
| | functionality of the generated prompt control will change |
| | based on this property. Also, once one or more values are |
| | entered or selected by the consumer, the server will know |
| | how to take these values formulate the appropriate filter |
| | or query expression. This spares the report author and |
| | consumer from understanding how to do that. |
| Select UI | This property controls the specific nature of the generated |
| | prompt control user interface. It allows the report author |
| | to choose from a variety of options such as check boxes, |
| | radio buttons or a single drop down list. |
| Auto-Submit | Setting the property to true will cause the generated |
| | prompt control to automatically accept the selected value, |
| | i.e., the consumer is not required to press a submit button |
| | to continue. Without this property, the report author |
| | would have to write an extensive amount of procedural |
| | code to achieve the same behavior. |
| Parameter | This indicates the name of the parameter with which the |
| | generated prompt control will be associated. It tells the |
| | server where to substitute values from this prompt |
| Default | The report author is able to provide one or more defaults |
| Selections | to display in the generated prompt control. How the |
| | default selections are interpreted and how they are |
| | rendered in the generated prompt control are dependent |
| | on the other declarative properties such as multi-select |
| | and select UI. Without this property the report author |
| | would have to understand the procedural code of the |
| | prompt and write the necessary code to select the |
| | appropriate defaults. |
| Data Format | Indicates the formatting used on the display values in the |
| | prompt control. For example, by setting the formatting |
| | appropriately the report author can ensure that values are |
| | shown as properly formatted currencies or dates. |
| Query | This indicates the query from the report to be used to add |
| | values to be shown in the prompt control. Using the |
| | Query, Use Value and Display Value properties, the |
| | server is able to formulate the appropriate database query |
| | to populate the generated prompt. |
| Use Value | This indicates the column from the report to be used as |
| | the use value for this prompt. This is the value that the |
| | server will use to satisfy the associated parameter. Using |
| | the Query, Use Value and Display Value properties, the |
| | server is able to formulate the appropriate database query |
| | to populate the generated prompt. |
| Display Value | This indicates the column from the report to be used as |
| | the display value for this prompt. The display value is a |
| | visual aid to the consumer to assist with selecting the |
| | proper use value. Using the Query, Use Value and |
| | Display Value properties, the server is able to formulate |
| | the appropriate database query to populate the generated |
| | prompt. |
| Static Choices | A static list of choices entered by the report author to be |
| | presented to the consumer. Each static choice will have |
| | an associated use and display value. |
| Cascade Source | This is the name of the parameter to be used to cascade |
| | this prompt. When this prompt control is generated, the |
| | server will apply an appropriate filter based on the |
| | current value of the cascade source. Without this |
| | property, the report author would have to understand |
| | the relationship between the two prompts and hand craft |
| | the appropriate filter. Also, the report author would |
| | have to write the procedural code to properly drive the |
| | two prompts. |

Search Prompt

The search prompt is very similar to the value prompt, except that it does not display all the choices. It provides an interface for search through the choices to find the value or values of interest. Without this declarative prompt, the author would have to understand searching syntax and write the necessary procedural code to perform the search and drive the prompt control.

| Property Name | Description |
|---|---|
| Required | As above |
| Multi-Select | As above |
| Parameter | As above |
| Default Selections | As above |
| Data Format | As above |
| Query | As above |
| Use Value | As above |
| Display Value | As above |
| Cascade Source | As above |

Type in Prompt

The type in prompt allows the consumer to enter values. Based on the properties of the prompt, validation will be performed on the entered data before it is accepted by the system.

| Property | |
|---|---|
| Name | Description |
| Required | As above |
| Multi-Select | As above |
| Parameter | As above |
| Default | As above |
| Selections | |
| Is Range | This property indicates whether or not the prompt control |
| | should accept ‘from’ and ‘to’ values. Rather than allowing |
| | selection of only discrete values, it allows selection of |
| | values such as ‘50 to 500’ or ‘greater than 1000’. This |
| | property can be used in conjunction with the multi-select |
| | property to build very complex filters. For example, without |
| | writing any code or understanding the database, it would be |
| | possible for the consumer to create a filter that says |
| | “Order Codes between 500 and 500, equal to 1201 and less |
| | than 5”. Without this property the report author would |
| | have to write complex code and logic for each report. |
| Multi-Line | Indicates that the generated text box is to accept data in |
| | multiple lines. |
| Hide Text | Indicates that entered data is to be hidden from the |
| | consumer. This is useful when entering sensitive data such |
| | as passwords. |
| Numbers | This property indicates that the prompt control is to only |
| Only | accept numbers. The generated prompt control will |
| | automatically ensure that values entered by the consumer |
| | are valid numbers. This is locale aware. Without this |
| | property, the report author would have to write all the |
| | procedural code to validate the input. |

Date Prompt

The date prompt allows either selection of a date by either selecting it from a calendar or typing it in by the consumer. It is locale aware.

| Property | |
|---|---|
| Name | Description |
| Required | As above |
| Multi-Select | As above |
| Select UI | As above |
| Parameter | As above |
| Default | As above |
| Selections | |
| Calendar | This property controls which calendar to use when selecting |
| Type | dates. There are a number of different calendar types. |
| | Examples of these include Gregorian, Julian and Japanese |
| | Imperial. Based on this property the server is able to |
| | generate the appropriate calendar and convert between the |
| | dates. Without this property the author would be required to |
| | understand what each calendar was, how to render it and |
| | how to convert values from it to what the database is |
| | expecting. With this property, the server handles all this |
| | automatically. |
| Is Range | This property indicates whether or not the prompt control |
| | should accept ‘from’ and ‘to’ values. Rather than allowing |
| | selection of only discrete values, this allows selection of |
| | values such as Jan 1 2002 to Jan 10 2002 or greater than |
| | Mar 1 2003. This property can be used in conjunction with |
| | the multi-select property to build very complex filters. For |
| | example, without writing any code or understanding the |
| | database, it would be possible for the consumer to create a |
| | filter that says “Order Dates between Jan 1 2002 and Jan 10 |
| | 2003, equal to May 29 2002 and less than Dec 30 2001”. |
| | Without this property the author would have to write |
| | complex code and logic for each report. |
| First Date | The earliest date to allow in the generated control. The |
| | server generates code to ensure that the consumer does not |
| | select a date before this value. |
| Last Date | The latest date to allow in the generated control. The server |
| | generates code to ensure that the consumer does not select |
| | a date after this value. |

Time Prompt

The type prompt allows selection of a time value. It is locale aware.

| Property | |
|---|---|
| Name | Description |
| Required | As above |
| Multi-Select | As above |
| Select UI | This property controls the specifics of the generated prompt |
| | control user interface. It allows the report author to choose |
| | from a variety of options such as a clock (which permits the |
| | consumer to choose values from a graphical clock) or |
| | a ‘type in edit box’ with validation by the system to ensure |
| | they are correct or meaningful.. |
| Parameter | As above. |
| Default | As above. |
| Selections | |
| Is Range | This property indicates whether or not the prompt control is |
| | to accept ‘from’ and ‘to’ values. Rather than allowing |
| | selection of only discrete values, this allows selection of |
| | values such as ‘1:00 pm to 5:00 pm’ or ‘greater than 3:00 |
| | pm’. This property can be used in conjunction with the |
| | multi-select property to build very complex filters. For |
| | example, without writing any code or understanding the |
| | database, it would be possible for the consumer to create a |
| | filter that says “Order Times between 1:00 pm and 5:00 pm, |
| | equal to 3:00 pm and less than 11:00 am”. Without this |
| | property the author would have to write complex code and |
| | logic for each report. |

Date/Time Prompt

The date time prompt is a really a combination of the date and time prompts. It is locale aware.

| Property | |
|---|---|
| Name | Description |
| Required | As above |
| Multi-Select | As above |
| Select UI | This property controls the specifics of the generated prompt |
| | control user interface. It allows the author to choose from a |
| | variety of options such as calendar, ‘clock’ or ‘type in edit |
| | box’ with validation. |
| Parameter | As above |
| Default | As above |
| Selections | |
| Calendar | As above |
| Type | |
| Is Range | This property indicates whether or not the prompt control |
| | should accept ‘from’ and ‘to’ values. Rather than allowing |
| | selection of only discrete values, this allows selection of |
| | values such as Jan 1 2002 1:00 pm to Jan 10 2002 5:00 pm |
| | or greater than Mar 1 2003 7:00 pm. This property can be |
| | used in conjunction with the multi-select property to build |
| | very complex filters. For example, without writing any code |
| | or understanding the database, it would be possible for the |
| | consumer to create a filter that says “Order Dates between |
| | Jan 1 2002 1:00 pm and Jan 10 2003 10:00 pm, equal to |
| | May 29 2002 11:00 am and less than Dec 30 2001 10:00 |
| | pm”. Without this property the author would have to write |
| | complex code and logic for each report. |
| First Date | The earliest date to allow in the generated prompt control. |
| | The server generates code to ensure that the consumer |
| | does not select a date before this value. |
| Last Date | The latest date to allow in the generated prompt control. |
| | The server generates code to ensure that the consumer |
| | does not select a date after this value. |

Interval Prompt

The interval prompt allows entry of a time interval. Values such as 5 days, 3 hours and 20 minutes can be entered.

| Property | |
|---|---|
| Name | Description |
| Required | As above |
| Multi-Select | As above |
| Parameter | As above |
| Default | As above |
| Selections | |
| Is Range | This property indicates whether or not the prompt control |
| | should accept ‘from’ and ‘to’ values. Rather than allowing |
| | selection of only discrete values, this allows selection of |
| | values such as 5 days and 2 hours to 10 days and 0 hours |
| | or greater than 30 days. This property can be used in |
| | conjunction with the multi-select property to build very |
| | complex filters. For example, without writing any code or |
| | understanding the database, it would be possible for the |
| | consumer to create a filter that says “Order Ages between 1 |
| | day and 3 days, equal to 7 days and less than 30 minutes”. |
| | Without this property the author would have to write |
| | complex code and logic for each report. |

Generated Prompt

The generated prompt is special. When a report is run, the server changes the Generated Prompt to one of the other prompts and its values set at that based on (but not limited to) the following information:

1. Data type of the associated parameter

2. Preferences stored in the database

3. The context of the associated parameter in the expression

4. Locale of the person running the report

Property Name Description

Required As above

Parameter As above

The following two examples are of the declarations produced in possible embodiments of this declarative specification tool. One skilled in the art would recognise that these declarations may be automatically generated by the report layout function 212, in collaboration with the query engine 230, using the results of the interaction of the report author 200 with the related prompt control during the authoring of a report layout.

A Value Prompt is declared as follows:

<selectValue parameter=“City” autoSubmit=“true” cascadeOn=“Country”

required=“false” selectUI=“listBox” refQuery=“Query1”>

<defaultSelections>

<defaultSelection>Ottawa</defaultSelection>

```
  </defaultSelections>
  <useItem refItem=“City”/>
</selectValue>
```

A Date Prompt is declared as follows:

<selectDate parameter=“Order Date” calendar=“Imperial” range=“true”

multiSelect=“true” required=“true”>

<defaultSelections>

<defaultSelection>2002-01-01</defaultSelection>

</defaultSelections>
</selectDate>

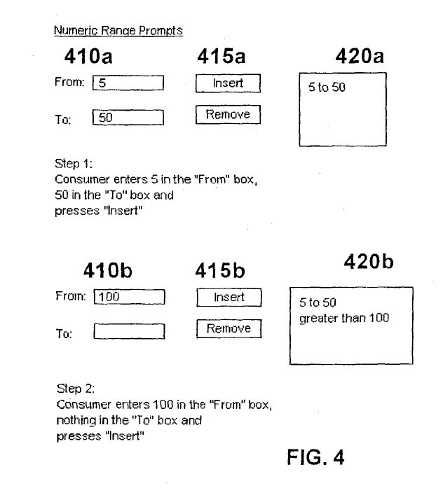

In FIG. 3 cascading prompts such as might be produced by one embodiment of the invention are illustrated. The consumer intuitively is guided to select the city of interest by three steps. In the first, a list of regions 310 permits selection of the relevant region (Europe), in the second a list of countries 320 is given, only the countries within the region being shown, rather than all countries, permitting easy selection of the required country (Scotland), and in the third step, a list of cities within a selected country is given, permitting the consumer to quickly select the city of interest (Inverness), without having to scroll through or search many thousands of potential entries.

FIG. 4 shows a similarly simplified user interface for selection numeric ranges such as might be produced by one embodiment of the invention. In this case the consumer initially selects a simple range using two numeric entry boxes 410a(values of 5 and 50) and a selection button 415a (Insert). The effect of this selection (5 to 50) is shown in a display box 420a. The consumer then enters a further set of values defining a second range, using the same numeric entry boxes 410b (values 100 and null) and selection button 415b (Insert). Again the result of the selection is shown in the display box 420b (5 to 50, greater than 100). When the consumer is satisfied with the combined selection, as shown in the display box 420b, the next step required to produce a report is taken.

It will be apparent to one skilled in the art that the above narrative describes concepts that can be applied to any situations where the customer and report author roles are filled by those with few if any programming skills, but where their needs can only be met through the availability of tools which provide them with a rich set of options. The description is therefore intended to cover those situations, and not be limited by the necessarily restricted set of examples given above.

What is claimed is:

1. A method for authoring reports and producing instantiations of the reports from data stored in a database, comprising the steps of:
authoring a report layout according to a report author's needs, using declarative principles and the database; and
creating reports according to the report layout and parameters chosen by a consumer and using the data stored in the database.

2. A method for authoring reports and producing instantiations of the reports from data stored in a database, comprising the steps of:
authoring a report layout, the authoring step comprising the steps of
a) presenting a report author with a mechanism with which to select prompt controls;
b) for each prompt control, providing the report author with a list of valid parameters from which to make a selection;
c) displaying a resulting report layout;
d) repeating steps a) to c) as required until the displayed report layout is deemed satisfactory by the report author;
using the report layout, the using step comprising the steps of
e) presenting a consumer (who may be the report author) with the report layout;
f) accepting from the consumer one or more parameter values selected using the prompt controls;
g) formulating a data request optionally using filters constructed from the one or more parameter values;
h) sending the data request to a data source;
i) receiving from the data source the results of the data request; and
j) providing the consumer with a report defined by the report layout and containing data based on the data received.

3. The method of claim 1 wherein the mechanism used to select prompt controls is a graphical user interface;

4. The method of claim 2 wherein the prompt controls and their parameters are defined by the database and system programmers.

5. The method of claim 2 wherein the list of valid parameters from which to make a selection in step b is based on declarative principles.

6. The method of claim 2 wherein a further step is included to check the prompts for consistency against the database.

7. A computer-based system for producing reports from data stored in a database, the system using prompts based on declarative principles, comprising:
means for authoring a report layout comprising:
a) means for allowing a report author to select prompt controls;
b) for each prompt control, means for providing the report author with a list of valid parameters from which to make a selection;
c) means for displaying a resulting report layout;
means for using the report layout comprising:
e) means for presenting a consumer (who may be the report author) with the report layout;
f) means for accepting from the consumer one or more parameter values selected using the prompt controls;
g) means for formulating a data request optionally using filters constructed from the one or more parameter values;
h) means for sending the data request to a data source;
i) means for receiving from the data source the results of the data request; and
j) means for displaying to the consumer a report defined by the report layout and containing data based on the received data.

8. The system of claim 7 wherein the means for allowing a report author to select prompt controls is a graphical user interface;

9. The system of claim 8 wherein the valid parameters comprises items selected from at least the following list: multi-select, required, select UI, query, use value, display value.

10. A computer program product comprising a computer useable medium having computer readable program code embodied therein for producing reports from data stored in a database, the system using prompts based on declarative principles, comprising:
computer readable program code devices configured to cause a computer to present a report author with a mechanism with which to select prompts;
computer readable program code devices configured to cause a computer to, for each prompt, provide the report author with a list of valid parameters from which to make a selection; and
computer readable program code devices configured to cause a computer to display a resulting report form.
